(19) United States
(12) Patent Application Publication
(10) Pub. No.: US 2015/0365480 A1
(43) Pub. Date: Dec. 17, 2015

(54) METHODS AND SYSTEMS FOR COMMUNICATING WITH ELECTRONIC DEVICES

(71) Applicant: Spidermonkey, LLC, San Francisco, CA (US)

(72) Inventors: Raymond Michael Soto, Mill Valley, CA (US); John Carney, Mill Valley, CA (US); Greg Thomson, Mill Valley, CA (US); Oleksandr Prokopyev, Emeryville, CA (US)

(21) Appl. No.: 14/740,967

(22) Filed: Jun. 16, 2015

Related U.S. Application Data
(60) Provisional application No. 62/012,448, filed on Jun. 16, 2014.
(60) Provisional application No. 62/047,571, filed on Sep. 8, 2014.
(60) Provisional application No. 62/158,193, filed on May 7, 2015.

(51) Int. Cl. H04L 29/08; H04L 12/26; H04L 12/28

(52) U.S. Cl. CPC H04L 67/125; H04L 12/2809; H04L 12/2827; H04L 12/2816; H04L 43/0876

(57) ABSTRACT

Methods and systems for communicating with electronic devices are provided. In some embodiments, a method for interacting with electronic devices may include a method for interacting with electronic devices on a network, the method comprising the steps of: searching for the presence of a signal generated by an electronic device; detecting the presence of an unregistered electronic device on the network; receiving schema from electronic device; associating the received device schema with a record of data in a database or other repository; and using the associated data to control a function of the electronic device through the network.

### CROSS REFERENCE TO RELATED APPLICATIONS

This application claims priority to and the benefit of the filing date of U.S. Provisional Application No. 62/012,448, filed on Jun. 16, 2014, entitled “RUN TIME ENVIRONMENT WITH TRAINABLE VOCABULARY TO CREATE WORKFLOW INTERACTIONS”, which is hereby incorporated by reference in its entirety. Additionally, this application claims priority to and the benefit of the filing date of U.S. Provisional Application No. 62/047,571, filed on Sep. 8, 2014, entitled “INTEGRATED SENSOR WALL PLATE APPARATUS AND RUN TIME ENVIRONMENT WITH TRAINABLE VOCABULARY METHODS”, and finally this application claims priority to and the benefit of the filing date of U.S. Provisional Application No U.S. Provisional Application No. 62/158,193, filed on May 7, 2015, entitled “RECOMMENDATION ENGINE FOR AUTOMATING INTERACTIONS BETWEEN AND AMONG PHYSICAL DEVICES AND DIGITAL SERVICES” all of the above referenced applications are hereby incorporated by reference in their entirety.

### APPENDIX TO THE SPECIFICATION

This application contains appendixes labeled as “Appendix_A”, “Appendix_B”, and “Appendix_C”. The entire contents of which are hereby incorporated by reference in their entirety.

### FIELD OF THE INVENTION

This patent specification relates to the field of methods and systems for communicating with electronic devices. More specifically, this patent specification relates to systems and methods that facilitate the integration and interaction of two or more electronic devices across a network.

### BACKGROUND

Electronic devices such as appliances, lights, security systems, environmental controls, and even irrigation systems are becoming “smart” in that they are now able to communicate with a user and even with other smart devices. The smart device industry is steadily improving and adding new features to allow for greater customization and communication with these devices. In addition, there are many devices that are virtual in nature and can be access through APIs. Collectively, “devices” include both smart (physical) devices and virtual services, or any physical or virtual device for which one can define states and actions and can access electronically over a network.

A drawback with smart devices is that each device typically has its own application for communication and control. They may also use different communication protocols and standards. In the market today there are aggregators who create services to work across multiple device manufacturers and thereby create a single interface to remotely control a collection of disparate devices. By way of example, a Nest thermostat does not natively communicate with a Belkin wifi plug or a Dropcam video camera. This creates multiple systems and networks within the home or office which are not able to effectively work together. However, some software providers do create integrated applications to control devices from multiple providers.

Existing automation solutions for electronic devices have several deficiencies. Users are limited to functionality provided by individual producers of specific devices and/or services and users are limited to functionality within a given provider's ecosystem, with little or no ability to add interactions between multiple devices and services based on the user's choice. Even with the aggregator services on the market, Users are limited to the remote control features offered by the aggregators. There is no open system whereby a User can define their own controls short of writing code. Additionally, users have little or no ability to benefit from targeted, recommended interactions among and between physical devices and digital services (Virtual electronic devices). Even with an automation platform with sufficient intelligence to allow user configurable scenarios and reactions, the user is left to try and create their own scenarios and reactions, or to manage multiple set of independent applications designed to manage smaller sets devices or services.

Therefore, a need exists for novel methods and systems for interacting with electronic devices. There also exists a need for novel methods and systems for interacting with electronic devices to create User defined and personalized workflow interactions between the electronic devices with disparate systems without writing code. Even without having to write code for personalized automations, there is a large portion of people that will need to have the personalized automation provided for them or provided through interfaces that collect personalized information to automatically generate automations. There is a further need for novel apparatuses for integrating sensors that are not required to be plugged into a power outlet, into wired sensors, and into environmental modulators resulting in a plurality of cables dispersed throughout the environment. Finally, there exists a need for novel systems and methods that facilitate the integration and interaction of two or more electronic devices.

### BRIEF SUMMARY OF THE INVENTION

Methods and systems for interacting with electronic devices are provided. In some embodiments, a method for interacting with electronic devices may include a method for interacting with electronic devices on a network, the method comprising the steps of: searching for the presence of a signal generated by an electronic device; detecting the presence of an unregistered electronic device on the network; receiving schema from, or associated with, electronic device; associating the received device schema with a record of data in a database, or other storage medium; and using the associated data to control a function of the electronic device through the network.

In further embodiments, the data on how to control a function of the electronic device may comprise data on the states and actions of the electronic device. In still further embodiments, the data on how to control a function of the electronic device may comprise data on interactions between the electronic device and other electronic devices. In still further embodiments, the data on how to control a function of the electronic device may allow the functions of two or more devices to interact with each other.

In further embodiments, a method for interacting with electronic devices on a network may further comprise the step of associating trigger event data (e.g. change of device state) with data on how to control a function (e.g. action) of the electronic device in a database. In still further embodiments, the method may further comprise the step of detecting a trigger event by an electronic device on the network. In still further embodiments, the method may further comprise the step of collecting data associated with the trigger event. In still further embodiments, the method may further comprise the step of retrieving data on how to control a function of the electronic device based on the collected data associated with the trigger event.

In further embodiments, a method for interacting with electronic devices on a network may further comprise the step of providing an Automation Engine (AE) where said AE is capable of managing devices uniformly based on device schemas defining states and actions and further where the AE supports the building and running of simple to complex reactions, without writing any code, based on changes in one or more states from one or more devices and the execution of one or more actions from one or more devices in response to the change of the nominated states. In still further embodiments where said AE can be used by virtual electronic device providers to link their service to a network of uniformly controlled devices. Examples may include, but are not limited to Security Services or Demand Response Services (energy management related service). In the case of a Security Service, the Automation Engine provides the ability to control physical devices on a network such as cameras and sensors as well as interface with Security Service Virtual electronic devices such as a call center, or data storage, or monitoring services. Through this invention then the Security Service could uniformly control physical devices for a User and tie in to Virtual electronic devices all without writing any code to power the device state and action controls (Reactions) or interface to Virtual electronic devices for providing the Security Service.

In further embodiments, a method for interacting with electronic devices on a network may further comprise the step of collecting context data of one or more electronic device(s) on the network. In still further embodiments, the method may further comprise the step of ranking multiple, potentially conflicting, requests to control a function of one or more electronic device(s).

In further embodiments, a method for interacting with electronic devices on a network may further comprise the step of providing Recommendations to the User for deploying automation Reactions to control their devices. As described above, the Automation Engine is capable of supporting the definition and execution of Reactions defined using device states and actions. The Recommendation Engine looks at many factors, including but not limited to User's registered device inventory, User's previous efforts regarding creating Reactions on their own, what Reactions Users, who have similar devices have created, in order to recommend and personalize Reactions for the User. In further embodiments, a method for interacting with electronic devices on a network and providing Recommendations may provide multiple recommendations and an ability for the User to provide weights or to directly select and customize a Reaction for their need. In still further embodiments, a method for interacting with electronic devices on a network and providing Recommendations may provide recommendations for Reactions that require a device that is not in the User's existing device inventory. In other words, the Recommendation Engine may recommend adding new devices to the device inventory in order to achieve new reactions.

In some embodiments, a method for interacting with electronic devices may include a computer implemented method for controlling electronic devices through dynamically generated graphical user interfaces, the method comprising the steps of; determining a first context of the client device; determining a first set of smart devices within the context; and creating a first graphic interface on the client device capable of controlling the determined first set of smart devices.

In further embodiments, a method for controlling electronic devices through dynamically generated graphical user interfaces may further comprise the steps of: determining a second context of the client device; determining a second set of smart devices within the context; and creating a second graphic interface on the client device capable of controlling the determined second set of smart devices.

In further embodiments, in a method for controlling electronic devices through dynamically generated graphical user interfaces the first graphic user interface and second graphic user interface may be configured to control different sets of smart devices, or may be automatically generated based on devices relevant to a context. Where different context may present a different set of devices based on the context. In still further embodiments, in a method for controlling electronic devices through dynamically generated graphical user interfaces the devices presented for control may be specific to one context only. In still further embodiments, in a method for controlling electronic devices through dynamically generated graphical user interfaces the devices presented for control may be specific to more than one space. As example, but not limiting, a Living Room context may present all of the devices present in the living room and a Dining Room context may present all of the devices in the dining room, but both context might also include a device that is the Baby Monitor or the Front Door Camera as no matter what room you are in those devices may be contextual to the User.

In further embodiments, a method for controlling electronic devices through dynamically generated graphical user interfaces may further comprise the step providing interface controls that aggregate like devices. As example, but not limiting, the User may have light bulbs from multiple manufacturers and the interface may provide a single control that uniformly adjusts the lights together, or some subset of lights together, or each light individually.

In further embodiments, a method for controlling electronic devices through dynamically generated graphical user interfaces may further comprise the step of receiving user input on the client device to control a function on a smart device located within the first context.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a system according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts a block diagram of an example of some of the programs of a system according to various embodiments described herein.

FIG. 5 illustrates a block diagram of a device discovery workflow according to various embodiments described herein.

FIG. 6 shows a block diagram of an example of a method for discovering devices according to various embodiments described herein.

FIG. 7 depicts a block diagram of a schema recommendation workflow according to various embodiments described herein.

FIG. 8 illustrates a block diagram of an example of a schema recommendation method according to various embodiments described herein

FIG. 9 shows a block diagram of an example of some of the programs of a system according to various embodiments described herein.

FIG. 10 depicts a block diagram of an example of a method of a dynamic remote control according to various embodiments described herein

FIG. 11 illustrates a block diagram of an example of some of the programs of a system according to various embodiments described herein.

FIG. 12 shows a block diagram of an example of some of the programs of a system according to various embodiments described herein.

FIG. 13 depicts a block diagram of an example of some of the programs of a system according to various embodiments described herein.

FIG. 14 illustrates a block diagram of an example of a reactor module logical workflow according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### DEFINITIONS

As used herein, the term “computer” refers to a machine, apparatus, or device that is capable of accepting and performing logic operations from software code. The term “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “electronic device” or sometimes “smart device” as used herein may include “physical electronic devices” as well as “virtual electronic devices”. Physical electronic devices may include but are not limited to devices commonly referred to as IoT (Internet of Things) devices. Virtual electronic devices may include, but are not limited to, virtual storage, physical storage, weather, traffic, etc, which are typically accessed through a network. An electronic device or smart device may be anything, such as a physical electronic device or a virtual electronic device for which one can define both states (readable data from a device) and/or actions (some event that causes some change in the device on, off, write data, set range, set value, send email, add row to database, make call, or any verb associated with the device that can be invoked via electronic means). An electronic device may be anything that has zero or more states and zero or more actions. Limiting to where actions can be invoked by electronic means and where states can be accessed via electronic means, but other than that an electronic device is anything. For example an electronic device could be a bit of data located at a URL. That electronic device has a state (e.g. What is the value of the data?) and it can be read electronically, and it has an action which is Set Value (this action causes the value to change). In addition, there are many devices that are virtual in nature (i.e. virtual electronic device) and can be accessed through APIs. In some embodiments, a physical electronic device as that term is used herein may be a type of electronic device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include; personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include; cell phones, smart phones, tablet computers, laptop computers, wearable computers such as watches, Google Glasses, etc. and the like.

The term “client device” which is preferably a type of “electronic device” as used herein is a type of computer generally operated by a person. In some embodiments, a client device is a smart phone or computer configured to receive and transmit data to a server or other electronic devices which may be operated locally or in the cloud. Non-limiting examples of client devices include; personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of client devices which are portable and easily carried by a person from one location to another may sometimes be referred to as a “mobile device” or “portable device”. Some non-limiting examples of mobile devices include; cell phones, smart phones, tablet computers, laptop computers, wearable computers such as watches, Google Glasses, etc. and the like.

In various embodiments, electronic devices (or “smart devices” as commonly used herein) are generally connected to other electronic devices or networks via different wireless protocols such as Bluetooth, NFC, WiFi, 3G, etc., that can operate to some extent interactively and autonomously. Several notable types of smart devices include smartphones (like the Apple iPhone or most of the devices running Android operating system), phablets and tablets (like the Apple iPad or Google Nexus 7), smartwatches, smart bands and smart keychains (as Prestigio Keys). The term can also refer to a ubiquitous computing device: a device that exhibits some properties of ubiquitous computing including—although not necessarily—artificial intelligence. Additionally, smart device may refer to electronic devices which may be used for home automation systems which use computer and information technology to control home appliances and features (such as windows or lighting). Systems can range from simple remote control of lighting through to complex computer/micro-controller based networks with varying degrees of intelligence and automation. Several notable types of smart devices include remotely operated locks, smart appliances, smart light bulbs and lighting, smart thermostats, security systems and cameras, intercoms, domotics, smart shading, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include wifi and cellular networks.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the Internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New methods and systems for interacting with electronic devices are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

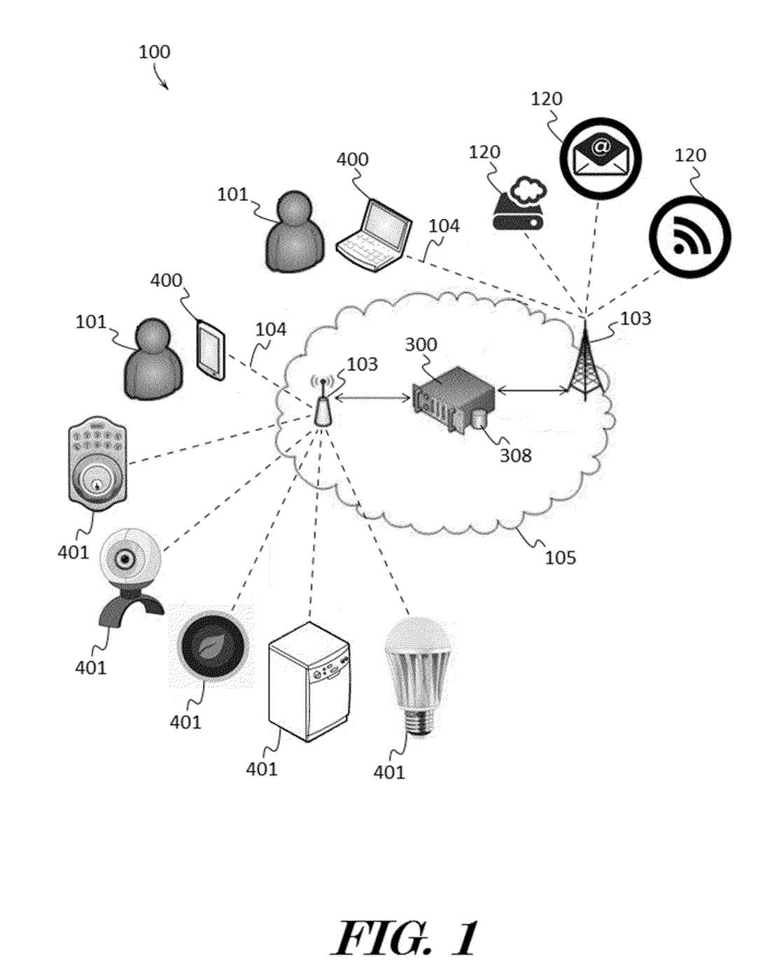

The present invention will now be described by example and through referencing the appended figures representing preferred and alternative embodiments. As perhaps best shown by FIG. 1, an illustrative example of some of the physical components which may comprise a system for interacting with electronic devices, “the system” 100, according to some embodiments is presented. The system 100 is configured to facilitate the transfer of data and information between one or more access points 103, electronic devices, 400, 401, 120, and servers 300 over a data network 105 with one or more databases on a data store 308 accessible by a server 300. An electronic device may include physical electronic devices such as client devices 400, smart devices 401, and virtual electronic devices 120, such as virtual services, or any physical or virtual device or service for which one can define states and actions and can access electronically. In this example, the system 100 comprises at least one client device 400 (but preferably more than two client devices 400) configured to be operated by one or more users 101. Wireless client devices 400 can be mobile devices such as laptops, personal digital assistants, IP phones and other smart phones, or fixed devices such as desktops and workstations that are equipped with a wireless network interface capable of sending data to one or more servers 300 with access to one or more data stores 308 over a wireless local area network (WLAN) 105. Smart devices 401 can be smart door locks, cameras and security systems, smart thermostats, smart appliances, smart light bulbs and lighting systems, or any other electronic device equipped with a network interface capable of sending data to one or more servers 300 and/or client devices 400 with access to one or more data stores 308 over a wired or wireless network 105. Virtual electronic devices 120 may be data service such as an email account, cloud storage, RSS feed, Facebook account, Twitter account, or any other service configured to send and receive data to a client device 400 and/or smart device 401 with access to one or more data stores 308 over a wired or wireless network 105. In some embodiments, the system 100 may be configured to control one or more smart devices 401 with one or more client devices 400 and/or virtual electronic devices 120. In other embodiments, the system 100 may be configured to control one or more smart devices 401 and/or virtual electronic devices 120 with one or more client devices 400 and/or virtual electronic devices 120.

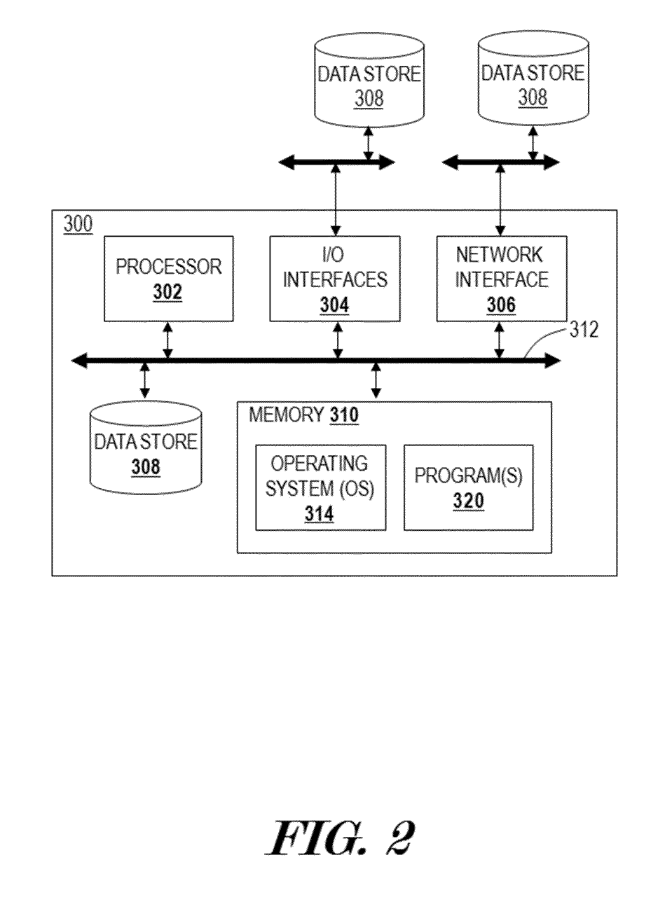

Referring now to FIG. 2, in an exemplary embodiment, a block diagram illustrates a server 300 of which one or more may be used in the system 100 or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (0/S) 314 and one or more programs 320. The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

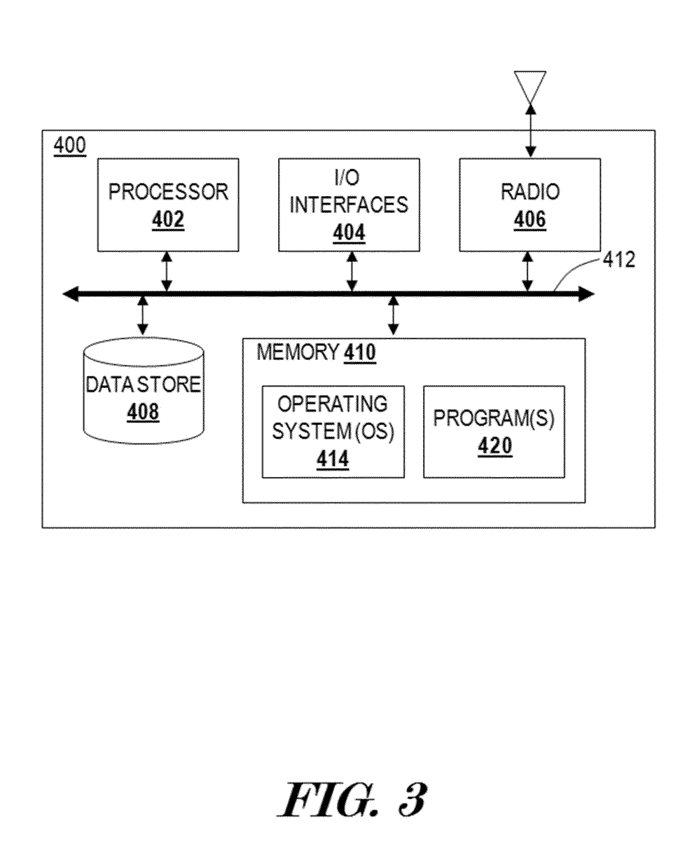

Referring to FIG. 3, in an exemplary embodiment, a block diagram illustrates a client device 400 of which one or more may be used in the system 100 or the like. Client devices 400 and smart devices 401 typically comprise similar hardware architecture. For the purposes of this disclosure, the diagram of FIG. 3 may be used to present a simplified hardware architecture for both a client device 400 and a smart device 401. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications. The I/O interfaces 404 can be used to receive images through a camera 500 and user input from and/or for providing system output. User input can be provided via, for example, a keypad, a touch screen, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may further include an imaging device, i.e. camera 500, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

In other embodiments, a client device 400 or smart device 401 may comprise a network interface may be used to enable the client device 400 or smart device 401 to communicate on a network, such as the Internet, the data network 105, the enterprise, and the like, etc. The network interface may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n) with a radio 406. The network interface may include address, control, and/or data connections to enable appropriate communications on the network.

The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420. The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network such as the system 100.

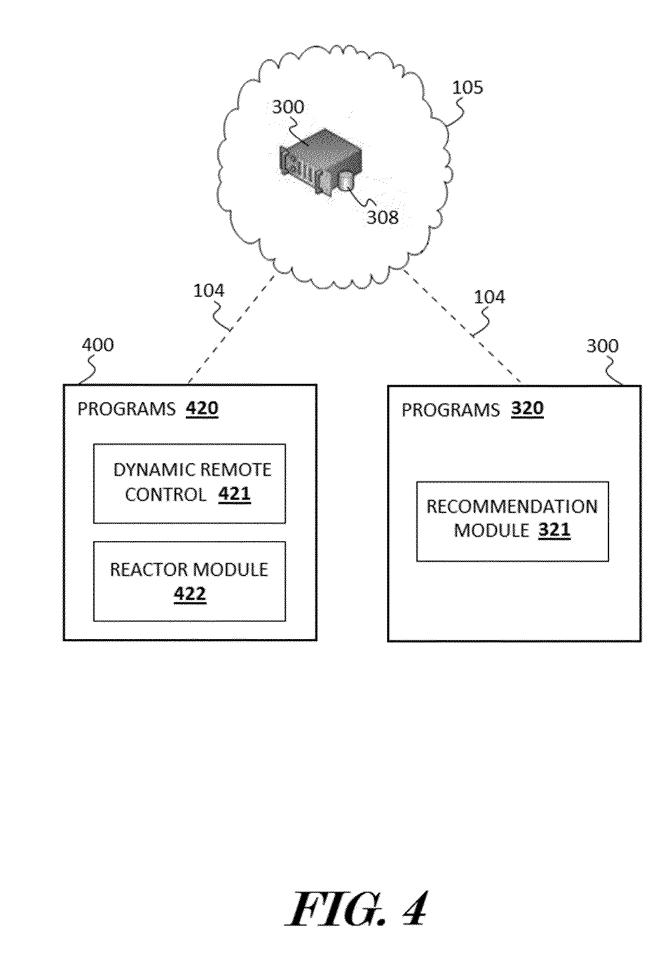

FIG. 4 depicts a block diagram of an example of some of the programs of a system 100 (FIG. 1) according to various embodiments described herein. In some embodiments, the programs 420 of a client device 400 may include a dynamic remote control engine 421 and a reactor module 422 while the programs 320 of a server 300 may include a recommendation module 321. In other embodiments, a dynamic remote control engine 421, reactor module 422, and/or recommendation module 321 may be run by a client device 400 and/or a server 300. Generally a program 420, 320, may include a rules engine or a module which may include one or more rules engines. In further embodiments, a dynamic remote control module 421 and a reactor module may be configured to allow a user of a client device 400 to control one or more other client devices 400, smart devices 401 (FIG. 1), and/or virtual electronic devices 120 (FIG. 1). When a reactor module 422 encounters a client device 400, smart device 401, or virtual electronic device 120 it is not configured to control, or as demanded by the User, a recommendation module 321 may be configured to provide data to the reactor module 422 with instructions on how to control the newly encountered a client device 400, smart device 401, or virtual electronic device 120. In some alternative embodiments, a reactor module 422 may comprise a dynamic remote control engine 421 and/or a recommendation module 321. Recommendations can occur on encountering a new device 400, 401, 120, or may be requested by the User such as when a user selects a menu option, such as in “Analyze my devices and tell by how I can use them better”, on a device 400, 401, 120, running a module or engine of the system 100.

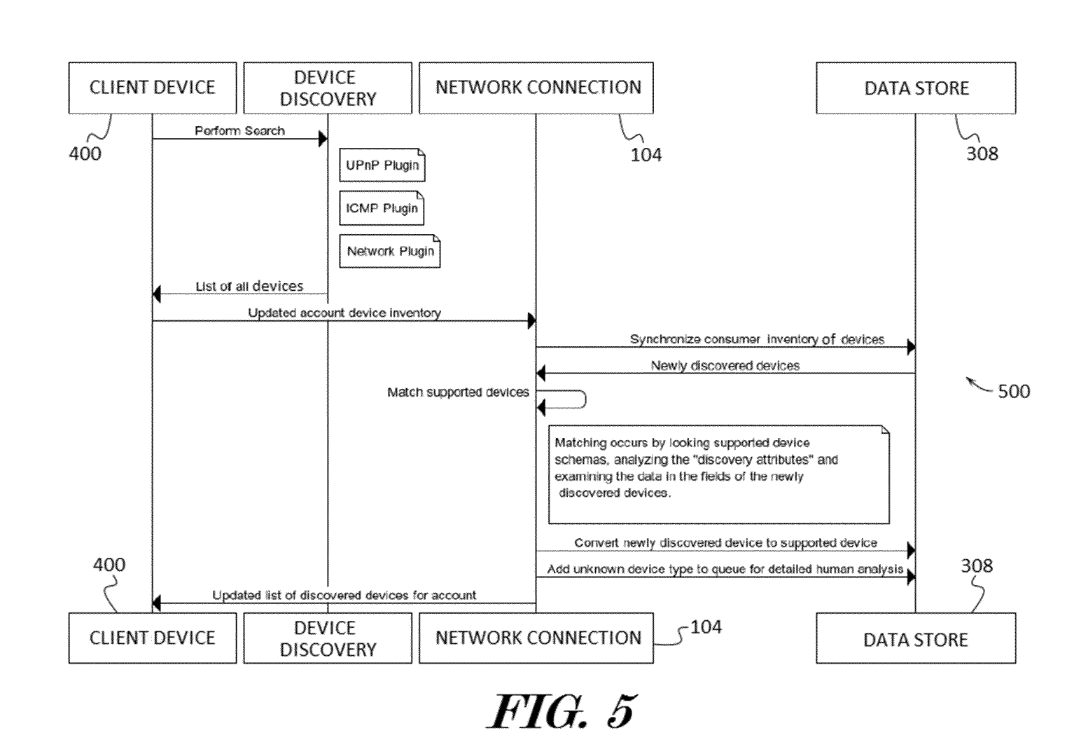

FIG. 5 illustrates a block diagram of a device discovery workflow (“the workflow”) 500 according to various embodiments described herein. The workflow 500 may be accomplished by a program, such as a reactor module 422 (FIG. 4), running on a server 300 (FIGS. 1, 2, 4) and/or, running on a client device 400 (FIGS. 1, 3, 4) such as a smart phone, computer, or other electronic device with access to a wired and/or wireless network 105 (FIGS. 1 and 4). The reactor module 422 may comprise a rules engine which may configure the client device 400 to perform steps of the workflow. In some embodiments, the client device 400 may be configured to search for any new client device 400, smart device 401 (FIG. 1), or virtual electronic device 120 (FIG. 1) which may be added to the network 105, such as a home network. In some embodiments, a client device 400 may be configured to constantly or periodically probe for any client device 400, smart device 401, or virtual electronic device 120 which may be newly connected to the network 105 of a user's home. In further embodiments, a reactor module 422 (FIG. 4) or other program of a client device 400 may be configured to probe the network for any newly connected client device 400, smart device 401, or virtual electronic device 120. Additionally, the reactor module 422 may maintain a list or database of all client devices 400 and smart devices 401 on the home network 105 to which the reactor module 422 may have access to and the reactor module 422 may synchronize this consumer inventory of client devices 400 and smart devices 401 to the data store 308. Furthermore, the reactor module 422 may maintain a list or database of all virtual electronic devices 120 to which the reactor module 422 may have access to through the network connection 104 and the reactor module 422 may synchronize this consumer inventory of virtual electronic devices 120 to the data store 308.

Once a newly connected client device 400, smart device 401 (FIG. 1), or virtual electronic device 120 (FIG. 1) is detected by the reactor module 422 (FIG. 4), the reactor module 422 may access a data store 308 through a network connection 104. The reactor module 422 may synchronize the listing of all the client devices 400, smart devices 401, or virtual electronic devices 120 including any newly connected ones to which the reactor module 422 may have access to. The reactor module 422 may retrieve one or more device schemas from the data store 308 that match or are otherwise associated with each physical device 400, 401, or virtual device 120. A device schema may comprise a set of instructions or rules by which the reactor module 422 may interact with and control each client device 400, smart device 401, or virtual electronic device 120 the reactor module 422 may have access to.

In some embodiments, a device schema may be matched to a device 400, 401, 120, by analyzing the discovery attributes, such as data provided by and about a device 400, 401, 120, when it connects to the home network of the client device 400 running the reactor module 422. For example, once a wireless camera is connected to the home network 105 the reactor module may detect the camera by the data the camera provides when connecting to the network 105. The reactor module 422 may then match the provided data to data associated with a device schema in the data store 308. The matched device schema may contain instructions on how to control the functions of the newly connected wireless camera. Once the device schema is retrieved by the reactor module 422 it may be incorporated into the rules engines of the reactor module 422 allowing the rules engine to control the functions of the newly connected wireless camera.

In some embodiments, data provided by and about a newly connected electronic device 400, 401, 120, may not match a device schema in the data store 308. This may occur when the newly connected device 400, 401, 120, is unknown to the system 100. The provided data on the unknown device 400, 401, 120, may then be stored in the data store 308 where it may be analyzed, optionally by a human, and a device schema for the unknown device or service may be added. When the reactor module 422 synchronizes the consumer inventory of devices 400, 401, 120, on the home network 105 newly available device schemas, such as for unknown devices or services, may be retrieved and current device 400, 401, 120, schemas may be updated.

Still referring to FIG. 5, the system is built upon the notion that as our technological world evolves, physical electronic devices 400, 401, and virtual electronic devices 120 will increasingly become exposed as data (that is pushed out) and actions (that are pulled in). Physical electronic devices 400, 401, and virtual electronic devices 120 will be parts of a complex orchestra that represent an/a individual's/family's/business' life and are put together by a conductor to achieve a unique and personalized representation of functionality.

To achieve an automated list of participants in this “orchestra”, the system has built functionality that can reside on a number of devices inside the consumers. This includes electronic devices 400, 401, such as, but not limited to; Android Phones, iPhones, Tablets, iPads; Android TV; FireTV, Google Nexus Player, and any other type or brand of electronic devices 400, 401. Agent software, such as a reactor module 422 runs on any or all of these listed platforms and is constantly probing the network to inventory all connected physical 400, 401 and virtual electronic devices 120. In some embodiments, probing/detection may occur according to the workflow of FIG. 5.

An example of a device schema (or definition) of a supported electronic device and the fields that are used in the discovery matching process is illustrated below:

```
{
“name”: “D-Link DCS-932L”,
“description”: “D-Link DCS-932L IP Video camera”,
“icon”: “images/devices/camera.png”,
“states”: [
      {
      “name”: “motion”,
      “type”: “Boolean”,
      “icon”: “images/devices/motion.png”,
      “description”: “Motion detected”
      },
      {
      “name”: “armed”,
      “type”: “Boolean”,
      “icon”: “images/devices/arm_camera.png”,
      “description”: “Camera is armed”
      }
],
“actions”: [
      {
      “name”: “turn_spotlight_on”,
      “icon”: “images/devices/flash.png”,
      “description”: “Turn spotlight on”,
      “params”: [
      {
      “name”: “length”,
      “type”: “Integer”,
      “description”: “Stay on for how many seconds?”
      }
      ]
      },
      {
      “name”: “arm_camera”,
      “description”: “Arm camera”,
      “icon”: “images/devices/arm_camera.png”,
      “params”: [
      {
      “name”: “enable_dropbox_upload”,
      “type”: “Boolean”,
      “description”: “Enable upload to dropbox?”
      },
      {
      “name”: “enable_twitter_post”,
      “type”: “Boolean”,
      “description”: “Enable posting to twitter?”
      },
      {
      “name”: “enable_streaming”,
      “type”: “Boolean”,
      “description”: “Enable streaming to dropbox?”
      }
      ]
      },
      {
      “name”: “disarm_camera”,
      “icon”: “images/devices/disarm_camera.png”,
      “description”: “Disarm camera”
      }
],
“discoveryAttributes”: {
      “modelName”: “DCS-932L”,
      “modelNumber”: “DCS-932L”,
      “deviceType”: “urn:schemas-upnp-org:device:Basic:1.0”,
      “manufacturer”: “D-Link”,
      “manufacturerUrl”: “http://www.dlink.com”,
      “modelDescription”: “Wireless Internet Camera”,
      “modelUrl”: “http://www.dlink.com”
},
“configurationParams”: [
      {
    “name”: “path”,
    “type”: “String”,
      “description”: “Streaming entry point”,
      “path”: “camera/path”,
      “isRequired”: true,
      “defaultValue”: “/mjpeg.cgi”
      },
      {
      “name”: “username”,
      “type”: “String”,
      “description”: “Camera access username”,
      “path”: “camera/username”,
      “isRequired”: true,
      “defaultValue”: “admin”
      },
      {
      “name”: “password”,
      “type”: “String”,
      “description”: “Camera access password”,
      “path”: “camera/password”,
      “isRequired”: true,
      “defaultValue”: “”
      }
  ]
}
```

This process of matching fields from a newly discovered device to available device schemas and their discovery attributes as illustrated in FIG. 5 for discovery and probing is preferably constantly occurring and may be used to discover and find all devices 400, 401, 120, that are attached the consumer's home network. When unknown device types are encountered, the instance of this unknown device may still be added to the device inventory on the account, but may remain in the unknown or unsupported state until a suitable device schema match is found. In a device schema, the “discovery attributes” are essentially fingerprints, and devices may be matched based on this data to determine data such as device type and functionality of incoming devices.

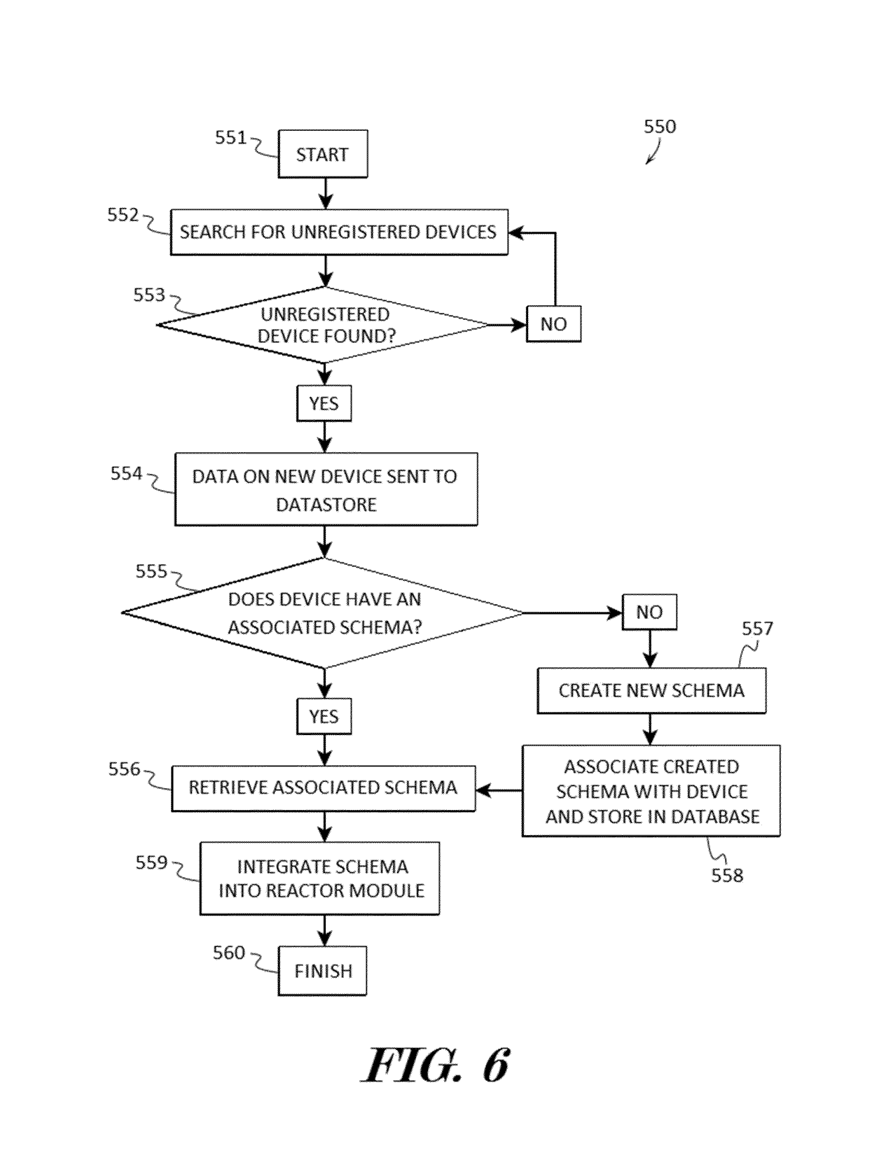

FIG. 6 shows a block diagram of an example of a method for discovering devices 400, 401, 120, (“the method”) 550 according to various embodiments described herein. The method 550 may be accomplished by a program, such as a reactor module 422 (FIG. 4), running on a server 300 (FIGS. 1, 2, 4) and/or, running on a client device 400 (FIGS. 1, 3, 4) such as a smart phone, computer, or other electronic device with access to a wired and/or wireless network 105 (FIGS. 1 and 4). The reactor module 422 may comprise a rules engine which may configure the client device 400 to perform steps of the method 550. In some embodiments, the method 550 may start 551 and the reactor module 422 may search for new or unregistered devices 400, 401, (FIGS. 1 and 3) or virtual electronic devices 120 (FIG. 1) in step 552. In some embodiments, an unregistered device may be a physical device 400, 401, or virtual device 120 that was not previously detected or setup on the network. If an unregistered device 400, 401, or virtual device 120 is not found or detected in decision step 553, the method may continue to step 552 and continue to search for new devices 400, 401, 120. If an unregistered device 400, 401, 120, is found or detected in step 553, the method 600 may continue to step 554 and data on the new device 400, 401, 120, may be sent to a data store 308 (FIGS. 1-5) comprising a database in step 554. A database may comprise a plurality of schemas with one or more schemas associated with data describing or identifying a device 400, 401, 120, or a function of a device 400, 401, 120. In some embodiments, a schema may comprise a device schema and/or a reaction schema. A device schema may comprise an abstract definition of the type or identity of a device 400, 401, 120. For example, a WiFi camera would have a device schema, and that schema would include states and actions of the WiFi camera. States may be “motion detected”, actions may be “upload recorded video to Dropbox”. A reaction schema may comprise a functionality of a device 400, 401, 120, and/or it may provide a definition of the way device schemas (types) may interact with each other. For example, a reaction schema for “Home Security” would say when device type WiFi camera detects motion then send message to mobile device schema (type) as a notification. This reaction schema would then be applied to specific instances of the device schemas listed on the consumers account. In a further example, if consumer turned on “Home Security”, that reaction schema would look for all matching devices of type “WiFi camera” and “mobile device” and create the necessary reactions (rules for interacting with each other) or retrieve one or more reactions or rules for interacting with each other.

Data on a new device 400, 401, 120, may be obtained when the new device 400, 401, 120, attempts to connect to a network to which the reactor module 422 is connected. This data may include data identifying the name, model number, account identity, or other data describing the device 400, 401, 120, and is typically broadcast by the device 400, 401, 120, when it connects or attempts to connect to a network.

Next in decision step 555, if the device 400, 401, 120, has an associated device schema in the data store, the associated schema may be retrieved from the data store in step 556. The data store may associate data describing a specific device 400, 401, 120, and data describing a class or group of devices 400, 401, 120, may be stored in the data store with one or more associated device schemas. If the new device 400, 401, 120, does not have an associated device schema in the data store, in some embodiments, the method 550 may proceed to step 557 in which a new device schema may be created. In further embodiments, if the new device 400, 401, 120, does not have an associated device schema in the data store data on the new device 400, 401, 120, may be stored in the data store and a human to access it to create a new device schema comprising instructions on how to control the functions of the new device 400, 401, 120.

Once a device schema has been created which is configured to control the functions of the new device 400, 401, 120, in step 557, the newly created device schema may be associated with the device 400, 401, 120, and stored in the database in step 558. Next, the method 550 may proceed to step 556 and the newly created device schema may be retrieved from the database on the data store. The one or more retrieved device schemas may then be integrated into the reactor module 422, thereby providing the reactor module 422 with instructions on how to control the functions of the new device 400, 401, 120, in step 559 and the method may finish 560.

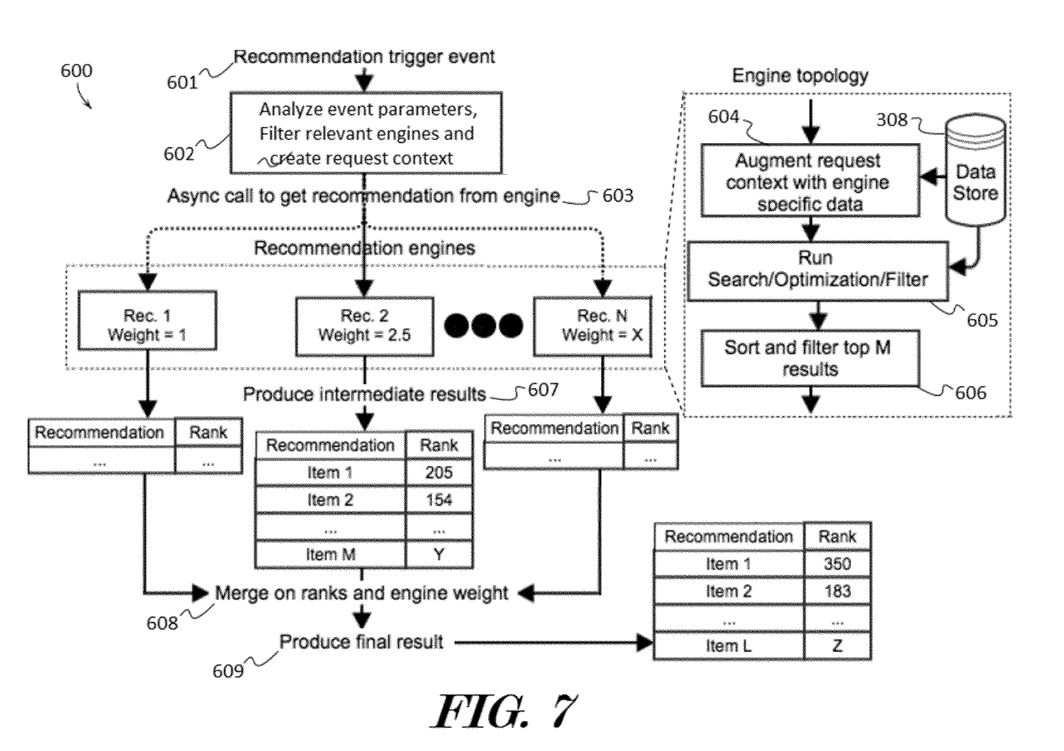

FIG. 7 depicts a block diagram of a schema recommendation workflow (“the workflow”) 600 according to various embodiments described herein. The workflow 600 may be accomplished by a program, such as a recommendation module 321 (FIG. 4), running on a server 300 (FIGS. 1, 2, 4) and/or a client device 400 (FIGS. 1, 3, 4) such as a smart phone, computer, or other electronic device with access to a wired and/or wireless network 105 (FIGS. 1 and 4). The recommendation module 321 may comprise a rules engine which may configure the client device 400 to perform steps of the workflow. In some embodiments, the workflow may be initiated by a recommendation trigger event 601. A recommendation trigger event may include any event or action which may be recognized by a client device 400, smart device 401, or virtual electronic device 120, such as a system message, user pressing a button, time of the day, a smart device 401 connecting to a network, a user initiated search on an electronic device, etc. The event parameters of the recommendation trigger event may be analyzed, relevant engines may be filtered, and a request context may be created 602 to form a query or request for device schemas and/or reaction schemas relevant to the trigger event. Additional query parameters may be supplied with the request defining expected results and constrains. The request may be pre-processed to filter relative recommendation engines and form Request Context which includes data which may be used to retrieve one or more recommendation engines with one or more device schemas and/or reaction schemas from a data store 308. Request context may be universal across all engines.

Async call or request may then be sent to all relative engines 603 and the process may wait until all/any engines respond within a desired time limit. Each engine may comprise one or more device schemas and/or reaction schemas and may be a separate system with its' own API and lifecycle.

Each of the engines augments request context with engine specific data 604. Depending on the engine nature, the process of search, optimization or filter is executed 605 and top M recommendations with relevance ranks associated with them are produced 606.

Recommendation lists are merged together on matching items; engine weight is used as relevance multiplier. For example the greater the engine specific data of a recommendation engine matches the data of the request context, the greater the weight of that recommendation engine. An intermediate listing of results may be produced 607 and then the result may be order, such as by listing recommendation engines with higher weights first to merge on ranks and engine weight 608 and a Final top L results of recommendation engines may be produced 609 which comprise one or more device schemas and/or reaction schemas relevant to the recommendation trigger event 601. For example a recommendation trigger event may comprise a Wifi camera connecting to the network which is detected by the client device 400. Data about the camera, such as type of camera, location of camera, etc. may be used to form a request context which may be used to retrieve one or more recommendation engines from a data store 308. Recommendation engines with data matching data of the request context may be given a weight and returned to the user of the client device 400 to produce a listing. A recommendation engine may be selected which comprise one or more device schemas and/or reaction schemas for controlling the functions of the WiFi camera.

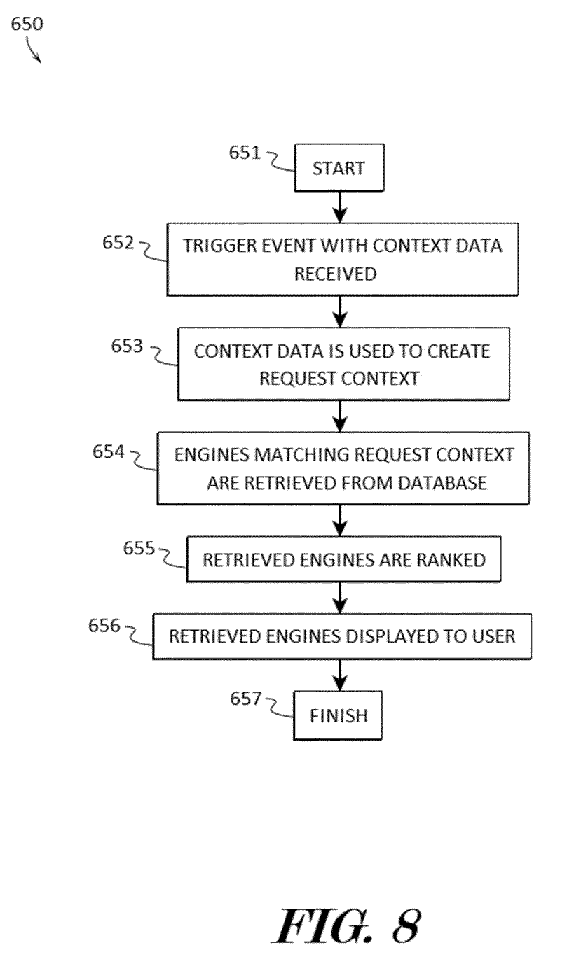

FIG. 8 illustrates a block diagram of an example of a schema recommendation method (“the method”) 650 according to various embodiments described herein. The method 650 may be accomplished by a program, such as a recommendation module 321 (FIG. 4), running on a server 300 (FIGS. 1, 2, 4) and/or, running on a client device 400 (FIGS. 1, 3, 4) such as a smart phone, computer, or other electronic device with access to a wired and/or wireless network 105 (FIGS. 1 and 4). The recommendation module 321 may comprise a rules engine which may configure the client device 400 to perform steps of the method 650 such as by using the workflow 600 of FIG. 7. In some embodiments, the method 650 may start 651 when trigger event data and optionally context data is received 652. Trigger event data may include any event parameters or data of the recommendation trigger, such as type of device which produced the trigger event, location of the device which produced the trigger event, time of the trigger event, etc. Context data may include any data about the context of the trigger event such as the location of a client device 400 (FIGS. 1, 3-5), smart device 401 (FIG. 1), a virtual electronic device 120, and location data of a device 400, 401, or virtual electronic device 120 relative to another device 400, 401, or virtual electronic device 120.

Next, the context data may be used to create a request context 653 which may be sent to a database in a data store 308 (FIGS. 1, 2, 4, 5, 7) comprising one or more recommendation engines. Each recommendation engine may comprise one or more device schemas and/or reaction schemas for controlling the functions of a client device 400 (FIGS. 1, 3-5), smart device 401 (FIG. 1), and/or a virtual electronic device 120 (FIG. 1). The recommendation engines with data matching the request context may then be retrieved from the database in 654.

Once the engines are retrieved, they may be ranked 655 such as by being given a weight. For example, higher ranked engines may comprise a greater amount of data which matches data from the request context. Next, the retrieved recommendation engines may be displayed to a user such as by being displayed on a display screen of a client device in 656 and the method may finish.

In an example of method 650, a trigger event such as a smart door lock connecting to the network of a client device 400 (FIGS. 1, 3-5) with context data may be detected and received 652 by the client device 400 or server 300 running a program such as a recommendation module 321. In other embodiments, a trigger event may be detected and received 652 by the client device 400 or server 300 running a program such as a reactor module 422 which may pass context data on the trigger event to a recommendation module 321. Context data may include the type of smart door lock, communication protocols of the smart door lock, location of the smart door lock, functions of the smart door lock, and/or any other data about the door lock which may be provided by the door lock or may be retrieved from a data base. The context data may be used to create a request context 653 which may comprise data which may be used to search a database on a data store comprising one or more recommendation engines. Engines with data matching all or portions of the request context may be retrieved from the database 654 and the retrieved engines may be ranked 655. In this example, recommendation engines with location, function, type, and communication protocol data matching data in the request context may be ranked higher that recommendation engines with only matching location and type data. The retrieved recommendation engines may then be displayed to a user 656 such as on a smart phone client device 400 and the user may then select one or more recommendation engines which comprise one or more device schemas and/or reaction schemas for controlling the functions of the smart door lock.

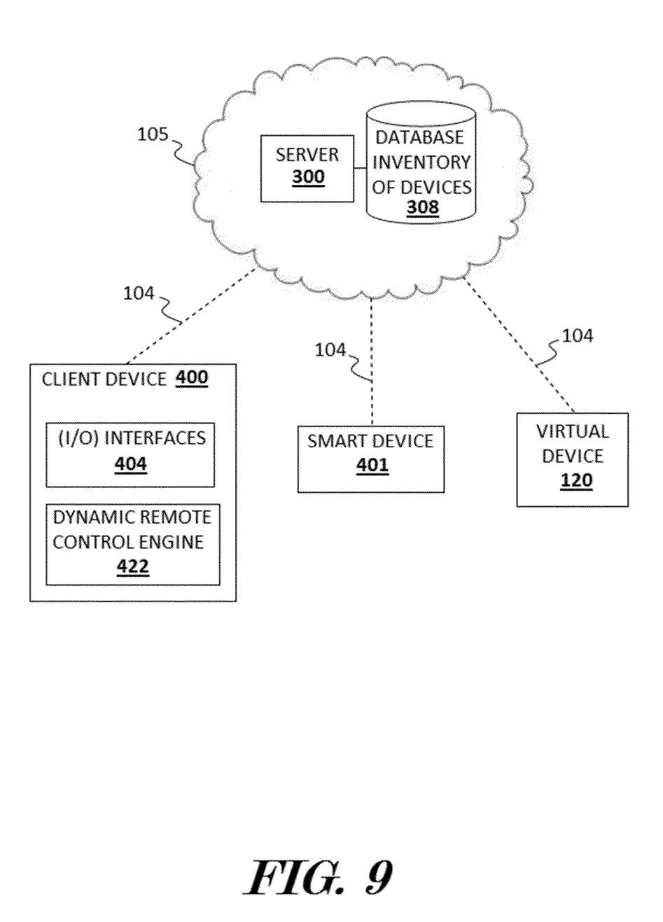

Referring now to FIGS. 4 and 9 in some embodiments, the system 100 may comprise a dynamic remote control engine 421 which may be run on a client device 400 to configure the client device 400 to function as a remote control for one or more client devices 400, smart devices 401, and/or virtual electronic devices 120 that may dynamically constructed to for contextual relevance. In a system where there are many remotely controlled client devices 400, smart devices 401, and/or virtual electronic devices 120, there are situations where some subset of those client devices 400, smart devices 401, and/or virtual electronic devices 120 are contextually relevant and thus may comprise the elements for control in a remote control interface or application. For example, in the field of Home Automation, there may be multiple automation devices created throughout and around the home. However, in any given room (or space within the home) only some subset of devices may be relevant for simplified access control. In the case of a dynamically constructed remote control one may be presented with a subset of devices and controllable functions related to a specific room or space.

In some embodiments, the system 100 may provide for automated discovery of one or more client devices 400, smart devices 401, and/or virtual electronic devices 120 in a home or business in order to create an inventory of remotely controllable devices; however that inventory may be created in any fashion that results in a set of one or more devices that may be divided into one or more overlapping or non-overlapping subsets based on contextual relevance. The system 100 may also be configured to uniformly control a set of devices with common navigation such that like devices from different providers can be used in the same manner as devices from a single provider. The system 100 may achieve this control through an architectural model leveraging device templates ingested by a common processing system, such as a reactor module 422 exposing states and actions in a common manner. In further embodiments, the system's 100 architecture for abstracting diverse client devices 400, smart devices 401, and/or virtual electronic devices 120 to a common usage model enables multiple controls to be collected together and presented in a common interface. The system 100 may further provide a means of assigning client devices 400, smart devices 401, and/or virtual electronic devices 120 to one or more spaces. This assignment can be done through automated discovery and automated location services (device beacons, radio signal locations, etc.), or can be done directly by the User by assigning devices to spaces.

In some embodiments, a dynamic remote control engine 421 may provide a dynamically constructed remote control for contextual relevance which may comprise the following elements: the presence of one or more remotely controllable client devices 400, smart devices 401, and/or virtual electronic devices 120; a means for assigning the client devices 400, smart devices 401, and/or virtual electronic devices 120 to different contexts (e.g. spaces); and a system and model for an abstraction layer for uniformly controlling a set of disparate client devices 400, smart devices 401, and/or virtual electronic devices 120 such as with a reactor module 422.

A dynamic remote control engine 421 may be configured to construct a remote control device/interface that is specific to a given context. Current state of the art provided remote controls are limited in some fashion such as one or more of the following: they have a fixed set of controls available in an interface; they have a set of controls that are built in to an interface manually for specific contexts; and they have a set of controls specific to a given provider or device ecosystem. A dynamic remote control engine 421 may be configured to construct a remote control device/interface that has none of the existing limitations.

A User may select context such as type of client device 400, smart device 401, and/or virtual electronic device 120, or space within which the client device 400, smart device 401, and/or virtual electronic device 120 are located, radius within which devices are located, etc. The context may also be automatically set based on locations of one or more users, client devices 400, smart devices 401, and/or virtual electronic devices 120, or some other mechanism. Once the context is established, the dynamic remote control engine 421 may use that context to select a set of client devices 400, smart devices 401, and/or virtual electronic devices 120 relevant to that context and construct an interface for simplified access and control of the one or more client devices 400, smart devices 401, and/or virtual electronic devices 120 in that context. A reactor module 422 and/or a recommendation module 321 may be in communication with the dynamic remote control engine 421 allowing it to automatically recognize new client devices 400, smart devices 401, and/or virtual electronic devices 120 added to a given context and add them to the rendered interface. The dynamic remote control engine 421 may also allow a user to customize the interface by adding or removing items from the rendered interface such that they do not show up (or may be added back later) and/or reorder the way the devices controls are displayed such that the more frequently used controls may be in easier position for access.

With regards to Home Automation, an example of a dynamic remote control engine 421 may be configured to present a dynamically constructed interface for a given room of a home on the display screen of a client device 400. A home might have client devices 400, smart devices 401, and/or virtual electronic devices 120 in several rooms but when the User in is a specific room context data may be used dynamically construct a remote control that only displays devices that are relevant to that room. This might include lights, switches, locks, and cameras in the given room and might also include devices that are relevant to the given room and other rooms at the same time (such as a thermostat control covering several rooms or the entire home).

With reference to FIG. 9, a User may be making use of a dynamic remote control engine 421, or some application that contains the dynamic remote control engine 421 on a client device 400 with input/output (I/O) interfaces 404 such as a display screen. The User may enter a given context and requests a remote control for that context. For purpose of discussion, assume the User has entered a Living Room and requests a dynamically constructed remote control for the Living Room. The dynamic remote control engine 421 may request a filtered set of devices from Inventory of Devices 702 and the dynamic remote control engine 421 may dynamically build an interface for uniform control of the devices on the display screen of the client device 400. This may include the ability to collect devices from different manufacturers in to a single control interface on the client device 400. For example, the Living Room could have lights from multiple manufacturers and the dynamic remote control engine 421 may create a control interface that can manage the brightness, on and off of all the lights simultaneously in the same control interface. It may also present the controls with a uniform appearance on the display screen for all lights by harmonizing the states and actions described by one or more device schemas and/or reaction schemas. The dynamic remote control engine 421 ability to uniformly access states and actions may be done by making use of device templates, device schemas, and/or reaction schemas, however other methods may be employed to harmonize controls of like devices. Back to our Living Room example, a harmonized control for lighting would allow for on, off, brightness, or color for one or a set of lights whether the lights are form the same maker or different makers. Similarly all cameras in a space, no matter what manufacturer, would preset in the interface in a common way for control viewing and access.

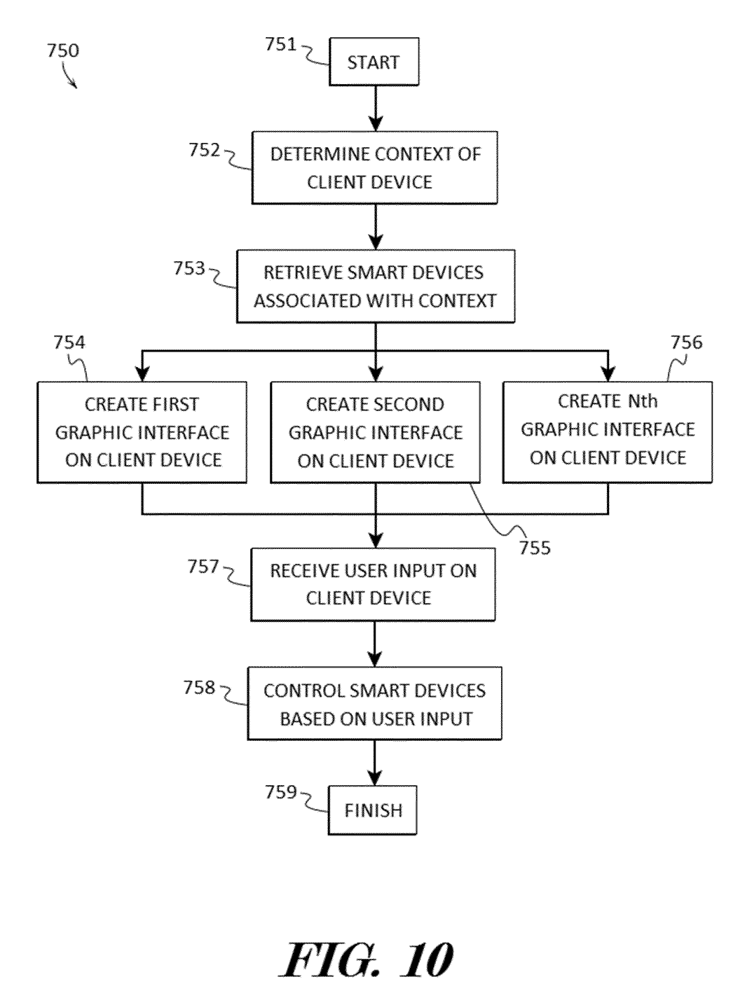

FIG. 10 depicts a block diagram of an example of a computer implemented method interfaces (“the method”) 750 to dynamically generate graphical user interfaces such as graphical control interfaces according to various embodiments described herein. The method 750 may be accomplished by a program, such as dynamic remote control engine 421 (FIG. 4), running on a server 300 (FIGS. 1, 2, 4) and/or, running on a client device 400 (FIGS. 1, 3, 4) such as a smart phone, computer, or other electronic device with access to a wired and/or wireless network 105 (FIGS. 1 and 4). The dynamic remote control engine 421 may comprise a rules engine which may configure the client device 400 to perform steps of the method 750. In some embodiments, a dynamic remote control engine 421 may be configured to form a graphical interface or other interface which may be displayed on the input/output (I/O) interface 404, such as a display screen, of a client device 400 which may allow the user to control functions of the dynamic remote control engine 421, recommendation module 321, and/or reactor module 422 by using an input/output (I/O) interface 404 of the client device 400. In further embodiments, a dynamic remote control engine 421 may be configured to form a graphical interface or other interface which may be displayed on the input/output (I/O) interface 304, such as a display screen, of a server 300 which may allow the user to control functions of the dynamic remote control engine 421, recommendation module 321, and/or reactor module 422 by using an input/output (I/O) interface 304 of the server 300. The dynamic remote control engine 421 may be configured to form a dynamic graphical interface which may dynamically change depending on the context of the a client device 400, smart device 401, and/or virtual electronic device 120 in communication with the dynamic remote control engine 421.

In some embodiments, the method 750 may start 751 and the context of the client device 752 may be collected and determined. The context of the client device 400 may include data and information on the location of the client device 400 relative to one or more other client devices 400 and/or smart devices 401, data and information on the functions of one or more client devices 400, smart devices 401, and/or virtual electronic devices 120 in communication with the dynamic remote control engine 421, and data and information on the device schemas and/or reaction schemas for controlling the functions of one or more client devices 400, smart devices 401, and/or virtual electronic devices 120 in communication with the dynamic remote control engine 421.

Next, the smart devices 401 associated with the context data may be retrieved from a data base in 753. In further embodiments, the client devices 400 and/or virtual electronic devices 120 associated with the context may be retrieved from a data base in 753. In further embodiments a first set of smart devices may be determined within the context of the client device in step 753. A first set of smart devices may include two or more devices 400, 401, and/or virtual electronic devices 120 which may be in proximity to each other, such as in the same room or building and which may interact with each other such as by being on the same network. Using the collected context data and the client devices 400, smart devices 401, and/or virtual electronic devices 120, a first graphic control interface may be created on the client device 754, a second control graphic interface may be created on the client device 755, and/or up to an Nth graphic interface may be created on the client device 756. Any number of graphic control interfaces may be created on the client device 755 which may differ in the number, types, and functions of the controls presented on each graphic interface depending on the on the context data and which client devices 400, smart devices 401, and/or virtual electronic devices 120 are accessible to the dynamic remote control engine 421.

In step 757, the user may provide input to the client device 400 using one or more graphic control interfaces presented on an input/output (I/O) interface 404 of the client device 400 such as a display screen. In other embodiments, the user may provide input to a server 300 using one or more graphic interfaces presented on an input/output (I/O) interface 304 of the server 300 such as a display screen in step 757. Next, in step 758 the functions of one or more smart devices 401 may be controlled based on the user provided input and the method 750 may finish 759. In other embodiments, the functions of one or more smart devices 401, client devices 400, and/or virtual electronic devices 120 may be controlled based on the user provided input, such as by using one or more device schemas and/or reaction schemas for controlling the functions of the one or more client devices 400, smart devices 401, and/or virtual electronic devices 120 in communication with the dynamic remote control engine 421.

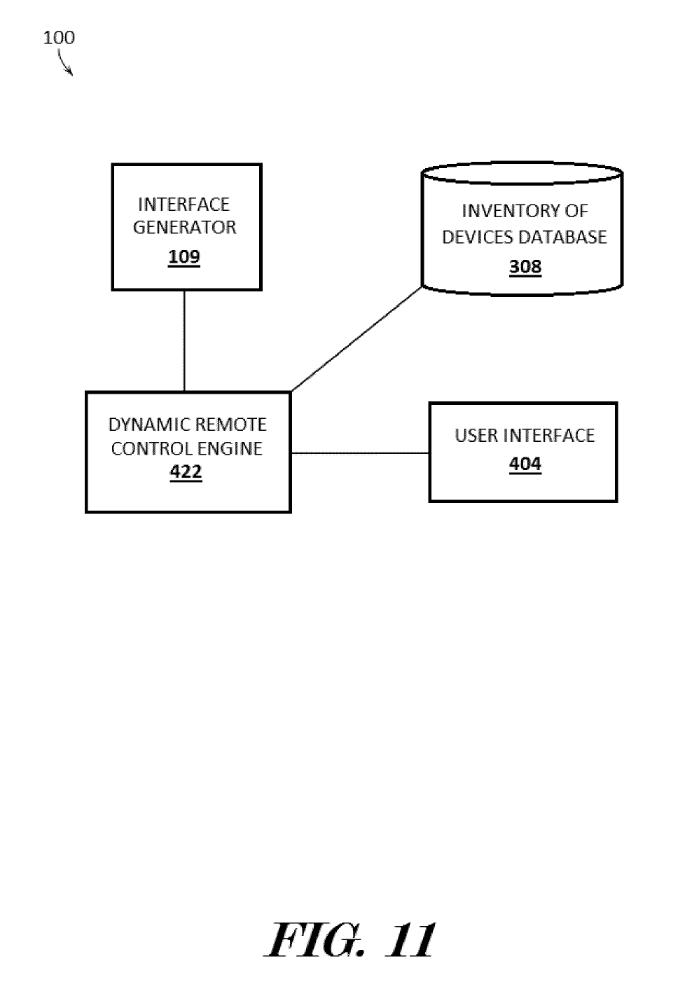

FIG. 11 illustrates a block diagram of an example of some of the programs of a system according to various embodiments described herein. A User may make use of a dynamic remote control engine 421, or some application that contains the dynamic remote control engine 421. The User may enter a given context and request a remote graphical control interface for that context. For purpose of discussion, assume the User has entered a Living Room and requests a dynamically constructed remote control for the Living Room. The dynamic remote control engine 421 may request a filtered set of devices from Inventory of Devices 308 and the user Interface Generator 109 to dynamically build a graphical control interface for uniform control of the devices. This includes the ability to collect devices from different manufacturers in to a single control device. For example, the Living Room could have lights from multiple manufacturers and the dynamically constructed remote control will create a control that can manage the brightness, on and off of all the lights simultaneously in the same graphical control interface. It may also present uniform looking controls for all lights by harmonizing the states and actions as explained in the device schemas and/or reaction schemas of the system. The Systems' ability to uniformly access states and actions is done by making use of device templates, however other methods may be employed to harmonize controls of like devices. Back to our Living Room example, a harmonized control for lighting would allow for on, off, brightness, or color for one or a set of lights whether the lights are form the same maker or different makers. Similarly all cameras in a space, no matter what manufacturer, would preset in the interface in a common way for control viewing and access.

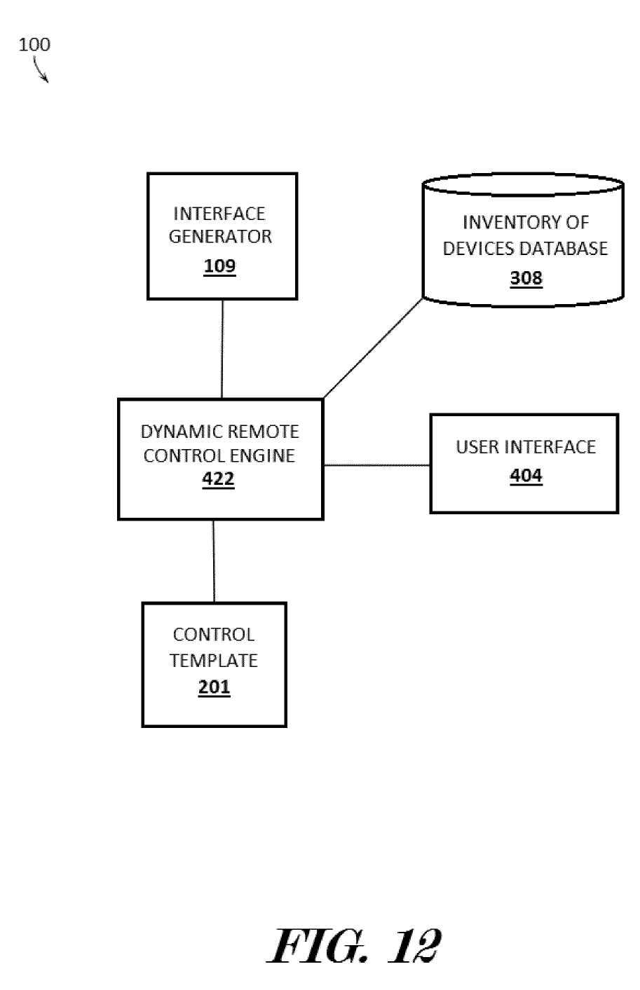

In the modification pictured in FIG. 12, a system and method are added for abstracting a definition of specific remote control device type controls. Recall in FIG. 11, leveraging the System, we are using Device Templates to abstractly describe devices types and their associated states and actions. With FIG. 12 we now introduce Control Templates that enable definition of new controls and how they map to Device Templates. This models allows for people to not only define new device types as metadata, but also now allows for the abstract definition of a control interface for a given device type. This enhancement supports that ability to define new remote control controls as metadata such that the application provider, or device providers, or the User can create new control definitions that will be rendered automatically based on devices found for a given context.

Thus with respect to FIG. 12, before the dynamic remote control engine 422 asks for the graphical control interface to be rendered, it first consults with Control Template 201 to determine what controls to construct in the graphical control interface for the devices found for the given context. For purpose of implementation, these operations could happen in slightly different order, or it could be for example the Interface Generator 109 that may request the Control Templates directly as part of the interface construction.

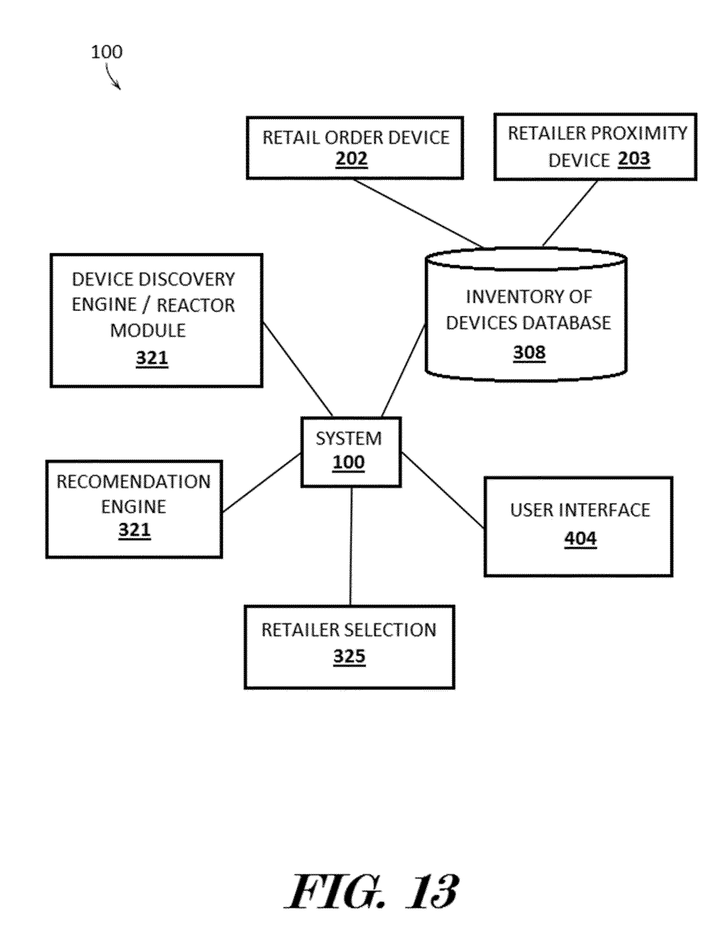

FIG. 13 depicts a block diagram of an example of some of the programs of a system according to various embodiments described herein. In some embodiments, the system may comprise retail devices. Let's call these retailer devices a Retail Order Device (ROD), and additionally the retailer can define a device that is a Retailer Proximity Device (RPD). The ROD may be a device that provides an ordering interface from within the system. The RPD may be a device the store places on premise at one or more locations. When the system is within proximity of an RPD then the system asks the User if they would like to add the RPD. At that same or proximate time the RPD may be linked to one or more ROD's so that from the RPD, the system can ask the User if they want to and the one or more related RODs. Users can choose to add RODs to their system by selecting them from a display or prompt, or if the system detects a RPD then the system can ask the User if they want to add the RPD and any associated RODs. Value of the RPD is that whenever the user may be in proximity to a specific retailer then retailer can provide direct access to an ROD such that the User can make an order electronically. For example, User walks in to coffee shop and the system detects an RPD. The system asks the user if they would like to add the RPD and an ROD for that retailer to their system. If yes, then the user can then also order through the ROD instead of waiting in line. On subsequent visits to the same retailer or different branch the user will automatically get the ROD if the system detects the RPD. The ROD can then ask the user of they want to order the same as a previous visit or a new order. The RPD and ROD may be implemented as a single device within the ssytem or multiple devices. The RPD is specifically about proximity to trigger order opportunity through ROD. The ROD is about ordering, whether in proximity or not. These devices can also be used in the system ecosystem to automate ordering. E.g. When I get to the coffee shop and I am detected by the RPD then order xxx. Or when event x happens then order y. This could also be use in house management of grocery supplies. For example, less than three rolls of toilet paper in the house then order case of 24 rolls. One can set up an order to be triggered by one or more events. Detection for in home ordering can happen in many ways (RFID, weight, location, etc) and not the point, The point is that given a detection we can create an event that triggers an action against an ROD. Detection can be via an RPD or some devices that tracks say inventory levels.

In further embodiments, a User Interface 404 may be part of a system application, such as a reactor module 422 to provide access to system functionality. In this case the User Interface 109 may be running on a mobile device or other device. The system 100 presents Retailer offers to the User in multiple contexts. Examples of contexts include providing a list of retailers to select from or providing notifications about opportunities to add specific retailers to user. Another example may be that the system, via a client application on a mobile device, that is making use of the User Interface 404, detects presence of a retailer device in a local proximity. In the case of Selecting from a list, the system may query Retailer Selection 325 for a list of available retailers and present the list through the User Interface 404. The user can then select one or more and then add them, via the system such as to a Personal Assistant or to their My Universe. The select list may provide access to both RPD and ROD devices. In the case of presenting the Retailed device(s) in the event of proximity detection, the system 100 will be notified by the Device Discovery Engine/reactor module 321. The reactor module 321 may be frequently examining local networks (wi-fi, Bluetooth, or others) for new devices. If a Retailer Proximity Device (RPD) is discovered then that device will be presented to the user through the User Interface 404. The user may choose to add the device to their system such as to My Universe (and add one time, for good, or not add). The User may also choose to be asked again on discovery of the RPD next time or not be asked again. If a RPD is accepted then RODs will immediately become visible to the user for ability to add. In some cases the ROD(s) may get auto added to the system My Universe if the RDP is accepted. In some cases, adding the ROD may require further acceptance beyond accepting the RDP.

It is not necessary to have an RPD in order to use an ROD. That is, the user may order through a ROD even if they are not in proximity to a RPD or may choose to interact with the ROD on a direct basis without enabling the interruption service of the RPD.

The ROD and RPD are devices published by the Retailer in confirmation with the system device schemas so that they operate uniformly within the system environment. Given the uniform nature of the devices, they can easily be control as common devices within the system. Some additional functionality is provided by the POR device in terms of its interface in to retail back office and Point-of-Sale (POS) ordering systems. In some instances system may provide ability for the retailer to include their own application code (e.g. via html embedded in the system interface) and in some instances the POR will simply provide a metadata list of inventory items and prices and then system will interface with the Retailer or POS directly and make the order. Another option where one or more credit card device are added by the user and the ROD order is placed through the POS and payment is automatically paid through a selected virtual device that represents the credit card.

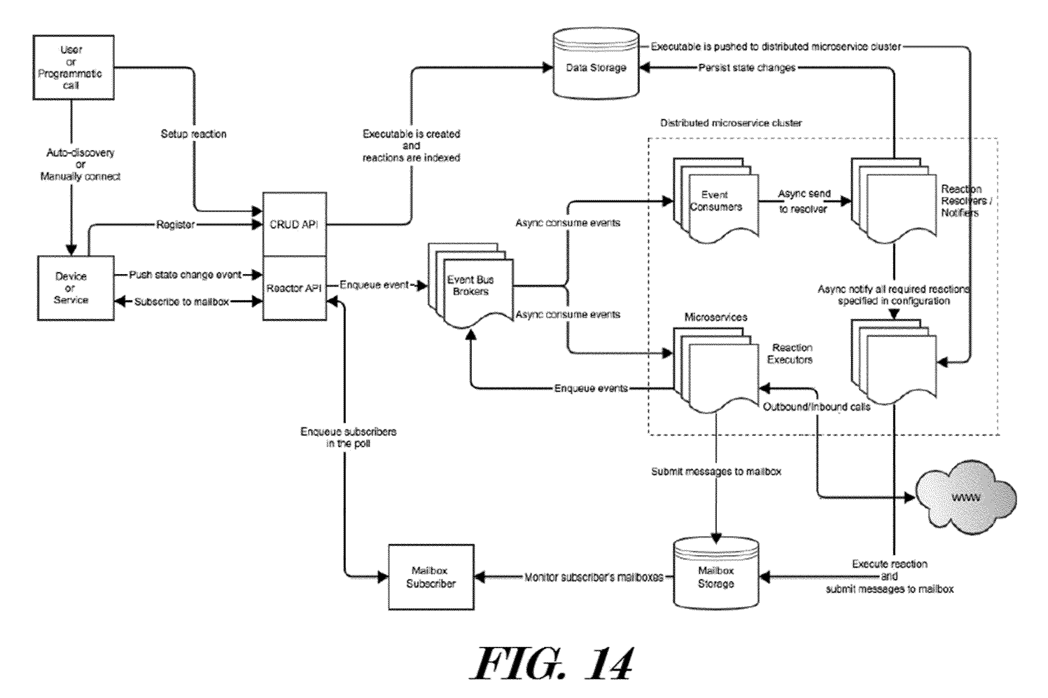

FIG. 14 illustrates a block diagram of an example of a reactor module logical workflow according to various embodiments described herein. In some embodiments, the workflow may comprise components such as a User or Programmatic call which may be a Real user or an Entity that setup platform via UI or direct calls to API. A Device or Service may comprise a Real hardware device, Software or a Service that participates in reactive platform. A CRUD API which may comprise a standard CRUD objects interface to configure the platform. A Reactor API which may include REST, RPC, Polling or Custom interface used in bi-directional communication with the platform. A Data Storage such as a distributed indexed data storage for platform configuration. An Event Bus Broker which may comprise a distributed persistent event bus for processing event stream. One or more event Consumers which may include micro-services for continuously consuming the event stream, further distributing work and monitoring work acceptance. One or more reaction resolvers/notifiers which may comprise micro-services for resolving state change events and notifying relative Reaction Executors. One or more reaction executors which may include micro-services for running reaction executable code and submitting messages to mailbox. One or more microservices which may comprise abstract and disparate microservices to provide custom application software layer that participates in reactive platform. A mailbox storage such as a distributed persistent data storage to handle messages awaiting to be delivered on next Device/Service availability. Also a mailbox subscriber may be included which may subscribes to all mailboxes declared by connected devices and proxies messages on earliest Device/Service availability.

In some embodiments, the workflow may comprise a Device/Service which may be registered by User or auto-discovered with the platform through CRUD API. A User may observe the device inside his account. The Device/Service may connect to platform and starts to asynchronously pushing its' state changes and listening for incoming actions. The User may setup a reaction with configuration to connect states and actions of all available devices/services in many-to-many relation. Reaction configuration may be saved, transformed to executable code and indexed in Data Storage. Executable code may be pushed to Reaction Executors. All device/service state changes may get serialized and pushed into Event Bus. Event bus may be consumed in parallel asynchronously by 2 groups: Event Consumers (Reaction path) and Abstract Micro-services (Application path). A reaction path may comprise an Event Consumer which serves as the entry point to a micro-service cluster. It may distribute the work among all relative participants. Additionally it may monitor that the work was accepted and acknowledged as processed. In case of a failure this or any other consumer may repeat the request. A reaction path may comprise an Reaction Resolver/Notifier which receives submitted state change events and persists them into Data Storage, and then query the Data Storage for relative to the state change reactions, and then asynchronously notifies Reaction Executors to commence a job run. Also, a reaction path may comprise a Reaction Executor which may run executable code pushed to the cluster earlier, as the result Device/Service actions are asynchronously produced and submitted to Mailbox Storage.

Application path may allow all events to be consumed and processed by a cluster of custom applications. Applications are absolutely abstract and are limited by developer imagination. The main I/O points may include: an ingress point for events consumption; an egress point for Mailbox Storage; and another egress point for submitting events back to the Event Bus for further processing. During application lifecycle it might do outbound calls to WWW, or accept inbound calls from WWW, or even have a persistent connection to multiple WWW entities. Previously connected Device/Service may be enqued into Mailbox Subscriber poll that may monitor all connected devices/services mailboxes. When any message becomes available in Mailbox Storage it may get instantaneously pushed to Mailbox Subscriber. A Mailbox Subscriber may be a proxying message further down to Device/Service.

Referring now to Diagram 2 of Appendix_B a block diagram of system integration options according to some embodiments is shown. In some embodiments, “discovery and connection of devices” may have two major components. One is the automated discovery and the second is the ‘automation bus’. The automated discovery simplifies the inclusion of new devices and the automaton bus simplifies making use of the devices without writing code to create new services. The service bus value proposition is further exemplified in diagram #2 in Appendix_B. This is novel in that remote control functions are aggregated across devices from different providers, and also in that they system has both auto discovery of devices and an automation bus to automate their functions. The automation bus allows third party services (e.g. Demand response or security companies) to offer their special services across the system platform. That is, they can bring their special sauce such as call center, monitoring and escalation for security or demand response rules for energy management and then use the system platform to integrate with and control devices. The third party only needs to define text rules for controlling devices and needs to define their services as ‘devices’ in the platform described herein. This might include a call device to call security, a security monitor devices to sending video to for review, or a demand response on/off data source that reactions can queue off of to determine whether or not to run. In preferred embodiments, no code is required on the system platform for others to deliver a new service. Optionally, small coding in their part to expose physical or logical services that the platform can ‘see’ may be used.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A computer implemented method for interacting with electronic devices on a network, the method comprising the steps of:
searching for the presence of a signal generated by an electronic device;
detecting the presence of an unregistered electronic device on the network;
receiving device schema data from electronic device;
associating the received device schema data with a record of data in a database; and
using the associated schema data to connect with and control functions of the electronic device through the network.

2. The method of claim 1, wherein the data comprises data on the states and actions of the electronic device.

3. The method of claim 2, wherein the data on how to control a function of the electronic device comprises data on interactions between the electronic device and other electronic devices on the network.

4. The method of claim 3, wherein the data on how to control a function of the electronic device allows the functions of two or more devices to interact with each other.

5. The method of claim 1, further comprising the step of associating trigger event data with data on how to control a function of the electronic device in a database.

6. The method of claim 5, further comprising the step of detecting a trigger event by an electronic device on the network.

7. The method of claim 6, further comprising the step of collecting data associated with the trigger event.

8. The method of claim 7, further comprising the step of retrieving data on how to control a function of the electronic device based on the collected data associated with the trigger event.

9. The method of claim 1, further comprising the step of collecting context data of the electronic device on the network.

10. The method of claim 9, further comprising the step of ranking the data on how to control a function of the electronic device retrieved from the database based on the collected context data of the electronic device on the network.

11. A computer implemented method for controlling electronic devices through dynamically generated graphical user interfaces, the method comprising the steps of;
determining a first context of the client device;
determining a first set of smart devices within the context; and
creating a first graphic interface on the client device capable of controlling the determined first set of smart devices.

12. The method of claim 11, further comprising the steps of:
determining a second context of the client device;
determining a second set of smart devices within the context; and
creating a second graphic interface on the client device capable of controlling the determined second set of smart devices.

13. The method of claim 12, wherein the first graphic user interface and second graphic user interface are configured to control different sets of smart devices.

14. The method of claim 11, further comprising the step of receiving user input on the client device to control a function on a smart device located within the first context.
